(19) United States
(12) Patent Application Publication
(10) Pub. No.: US 2011/0046979 A1
(43) Pub. Date: Feb. 24, 2011

(54) METHOD AND SYSTEM FOR PERSONALIZED GUIDELINE-BASED THERAPY AUGMENTED BY IMAGING INFORMATION

(75) Inventors: Paola Karina Tulipano, Brooklyn, NY (US); Lilla Boroczky, Mount Kisco, NY (US); Michael C. Lee, New York, NY (US); Victor Paulus Marcellus Vloemans, Rosmalen (NL); Ingwer Curt Carlsen, Hamburg (DE); Roland Opfer, Hamburg (DE); Charles Lagor, Ardsley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/989,805

(22) PCT Filed: May 4, 2009
(86) PCT No.: PCT/IB09/51822

§ 371 Date: Oct. 27, 2010

Related U.S. Application Data
(60) Provisional application No. 61/051,895, filed on May 9, 2008.

(51) Int. Cl. G06Q 50/00; G06F 17/30

(52) U.S. Cl. 705/2; 707/776; 707/E17.014

(57) ABSTRACT

When treating a patient, clinical decision support system (CDSS) guidelines are employed to assist a physician in generating a treatment plan. These plans are generated using both imaging and non-imaging data. To accomplish this, the CDSS is interfaced with imaging systems (CADx, CAD, PACS etc.). A data-mining operation is performed to identify relevant patients with similar attributes such as diagnosis, medical history, treatment, etc from imaging and non-imaging data. Natural language processing is employed to extract and encode relevant non-imaging (textual) data from relevant patients' records. Additionally, an image of a current patient is compared to reference images in a patient database to identify relevant patients. Relevant patients are then identified to a user, and the user selects a relevant patient to view detailed information related to medical history, treatment, guidelines, efficacy, and the like.

The present application finds particular utility in clinical decision support systems (CDSS). However, it will be appreciated that the described technique(s) may also find application in other types of decision support systems, imaging systems, and/or medical applications.

The management of patient diseases (e.g., cancer) and treatments through the use of guidelines, such as care pathways, protocols, and clinical practice guidelines (CPG), can assist both patients and health care providers by outlining the best medical care practices, reducing overall medical practice variability, and providing high-quality care at managed costs. According to the Institute of Medicine, guidelines are systematically developed statements to assist practitioner and patient decisions about appropriate health care for specific clinical circumstances. Guidelines are generally disseminated as static paper-based documents, thus limiting their usage in daily clinical practice.

During the last decade, many efforts have emerged to computerize medical guidelines. In an effort to computerize guidelines, guideline authoring tools have been created to extract and encode paper-based guidelines in computerized form. For instance, GASTON is a generic architecture for design and development of guideline-based decision support systems developed at the Eindhoven University of Technology and currently part of the commercial company known as Medecs. SAGE (Shareable Active Guideline Environment) is a standards-based guideline environment developed by several academic institutions and industry partners. PROFORMA is another guideline representation, authoring, and execution environment developed at the Advanced Computation Laboratory in the UK.

While many guidelines are now available electronically, it is not sufficient to simply represent the guidelines electronically; guideline interactivity and integration into the daily clinical workflow are necessary. Implementing guidelines in computerized CDSS is one method to improve acceptance and promote the daily use of guidelines. CDSS can offer guideline-based evidence and recommendations at the point of care, allowing physicians to integrate guidelines effectively into their workflow. Various studies have shown that guideline-based decision support systems can improve the quality of care. A number of guideline-based CDSS have been developed and include the PRESGUID system for drug prescription advising, the CompTMAP system for major depressive disorder, and the ATHENA decision support system for hypertension.

Conventional guideline-based CDSS fail to address the multi-disciplinary nature of clinical practice by focusing on one narrow domain and clinical information alone. There is a need in the art for systems and methods that facilitate overcoming the deficiencies noted above by facilitating communication and cooperation between guideline-based CDSS systems and other systems such as patient imaging systems.

In accordance with one aspect, a guideline-based clinical decision support system (CDSS) includes a guideline engine that executes one or more guidelines for treating a current patient, and an external image system that interfaces with the guideline engine.

In accordance with another aspect, a method of incorporating medical image information into clinical decision support system (CDSS) information includes comparing attributes of a current patient to attributes of one or more reference patients retrieved from external imaging systems, optimizing a custom treatment plan, and generating a custom guideline for the current patient as a function of user input and one or more treatment guidelines associated with the relevant reference patients.

One advantage is that image information is incorporated into guideline-based CDSS decisions in order to facilitate personalized treatment of the patient.

Another advantage resides in interfacing and facilitating communication between CDSS software and historical patient image data.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting.

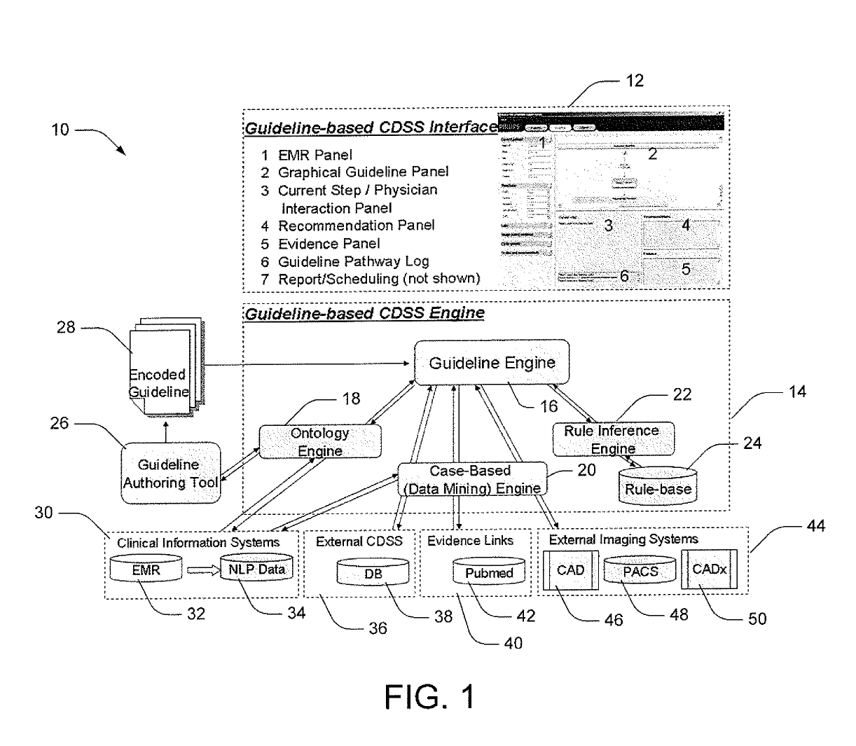

FIG. 1 illustrates a guideline-based clinical decision support system (CDSS) that incorporates both clinical and imaging information for medical decision making.

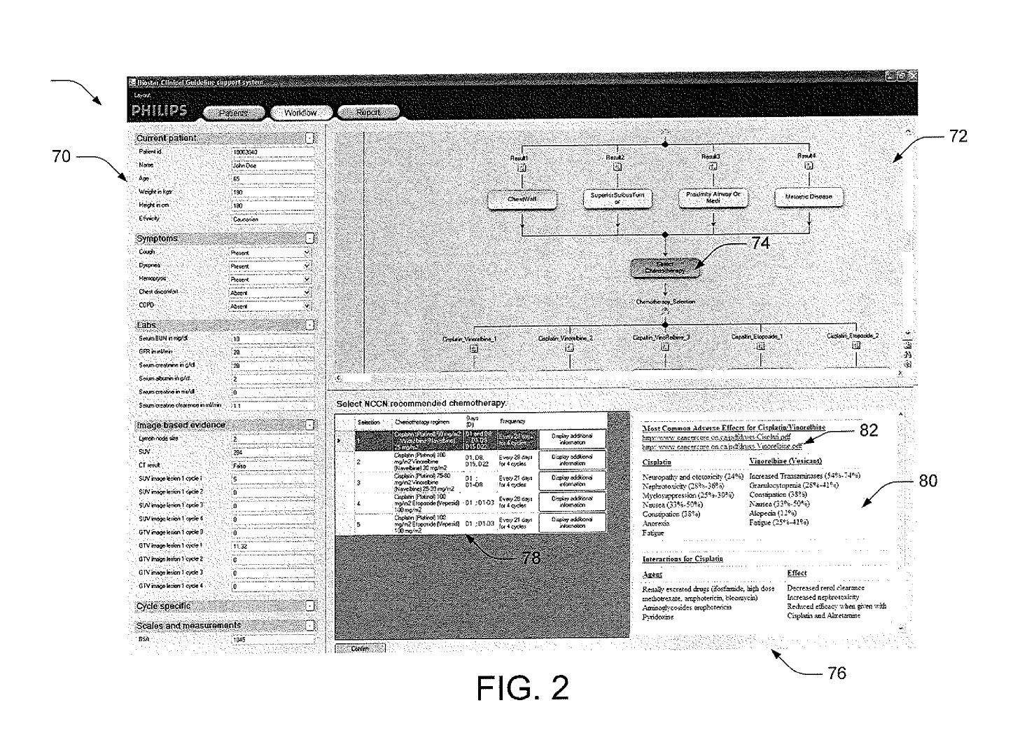

FIG. 2 is a screenshot of the CDSS interface, in accordance with various aspects described herein.

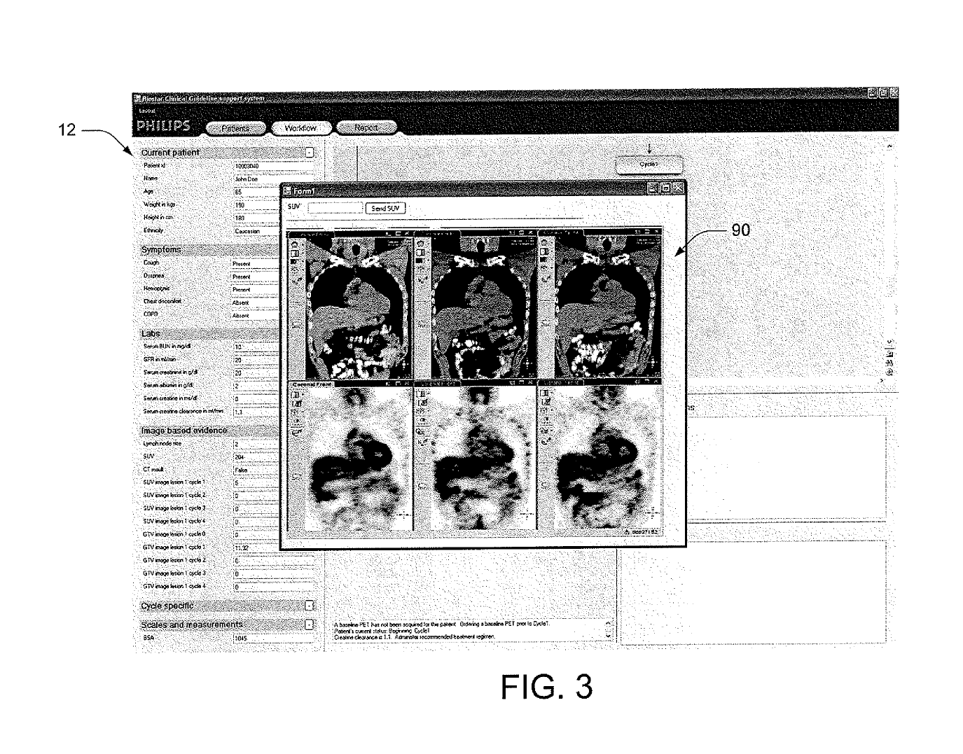

FIG. 3 is a screenshot of the CDSS interface wherein a link to external imaging software and/or database(s) has been selected causing a window to be opened displaying patient images retrieved by a software module that accesses the external imaging software and/or database(s).

FIG. 1 illustrates a guideline-based clinical decision support system (CDSS) 10 that incorporates both clinical and imaging information for medical decision making. System 10 includes: 1) means for incorporation of imaging and clinical information for providing evidence and recommendations and enabling image-based data inference, 2) interfaces and internal communication means between other imaging sources such as computer-aided detection (CAD) systems, computer-aided diagnosis (CADx) systems, and picture archiving and communication systems (PACS), 3) case-based (data mining) modules and case-based results presentation means for personalized care and case-based inference, and 4) means for incorporation of textual information (e.g. natural language processed (NLP) free-text imaging reports).

The system 10 facilitates communication between a clinical decision support system engine and PACS or other imaging databases. For example, after a target patient is diagnosed, the target patient is typically placed on an initial treatment regimen. After a selected duration, the target patient is imaged again to determine progress, e.g., how much a tumor has decreased in its volume. The images are compared by computer to get an objective measurement of change, such as volume change, texture change, and the like. The system 10 performs a case-based data mining operation to identify reference patients with similar attributes, e.g., a similar diagnosis, similar images, similar treatment, similar medical history, and the like (the attributes of reference patients being stored in, for example, external imaging systems along with images, or in an EMR, etc.). Based on a distance metric, the most similar reference patients are selected and their treatment, results, and the like are utilized to personalize a custom treatment guideline for the current or target patient. These processes are repeated periodically during the course of treatment to adjust and optimize the personalized treatment plan for the target patient.

The system 10 includes a guideline-based CDSS graphical user interface (GUI) 12 that has, for example, an electronic medical record (EMR) panel 1, a graphical guideline panel 2, a current step/physician interaction panel 3, a recommendation panel 4, an evidence panel 5, a guideline pathway log 6, a report/scheduling panel (not shown), etc. The GUI is coupled to a guideline-based CDSS engine 14 that includes a guideline engine 16 that is coupled to each of an ontology engine 18, a case-based engine 20 (e.g., a data mining engine), and a rule inference engine 22. The rule-inference engine is further coupled to a rule database 24. The guideline engine interacts with the case-based engine and external imaging system(s) to facilitate the optimization of personalized treatment plans and the generation of custom guidelines for a current or target patient as a function of guidelines used for similar reference patients. It will be appreciated that the various “engines” described herein include one or more processors that execute machine-executable instructions, and memory that stores, machine-executable instructions for performing the various functions described herein.

An enhanced guideline authoring tool 26 is coupled to the ontology engine 18, and permits a user to encode one or more guidelines 28, which are employed by the guideline engine 16. The ontology engine is additionally coupled to a clinical information system(s) 30, which includes an EMR database 32 and NLP data 34. The case-based engine 20 is also coupled to the clinical information system, as well as to each of an external CDSS 36 that includes a CDSS database 38, one or more evidence links 40 that include one or more databases 42, and one or more external imaging systems 44. The imaging system 44 includes CAD system(s) 46, CADx system(s) 48, and/or PACS 50, and the like.

According to an example, a guideline 28 is encoded using the guideline authoring tool 26. When encoding the guideline, several attributes are set to allow access to the clinical information systems 30 (including EMR data 32 and NLP data 34, etc.), external CDSS 36, evidence links 40 (e.g. Pubmed), and external imaging systems 44. Once the guideline is modeled and encoded electronically, the guideline engine 16 executes the guideline and interacts with the various systems to retrieve or analyze the appropriate information at each activity step within the guideline. At each step, the guideline engine interacts with the ontology engine 18, case-based engine 20, or the rule-based engine 24. The ontology engine 18 maps local terminology to medical concepts to promote interoperability between systems.

According to an example, the ontology engine 18 maps descriptive terms from different hospital systems to a common universal medical concept. For instance, two different hospital systems may have a checklist for recording patient signs (or symptoms) upon admission of a patient. A first hospital checklist may include “scaly skin” and the second may include “flaky skin,” both of which may be mapped to the medical concept “dermatitis” and the rule sets associated therewith.

In another example, a first medical clinic information system may use the terms “scrape,” “cut,” and “gash” to describe skin wounds, while a second clinical information system may refer to the same wounds with the terms “abrasion,” “incision,” and “laceration.” The ontology engine 18, in this example, maps such terms to a universal medical concept and associated rule base relating to skin wounds. In this manner, treatment guidelines are anchored to universal medical concepts, and local variations in terminology are identified and mapped to the universal concepts to provide interoperability despite the local terminology variation.

The case-based engine 20 provides personalized information retrieval, such as retrieval and presentation of similar cases with respect to reference patients with known outcome or therapy plan from a reference patient database to a current case in question, within the guideline-based CDSS. The rule inference engine (a rule-based engine) 22 ensures that any recommendation or decision made by the CDSS also considers various rules in the rule database 24 by providing for example appropriate alerts (e.g., dosage or over-dosage alerts, drug-drug interaction alerts, patient allergy alerts, etc.) or recommendations within the guideline-based CDSS. For example, the rule inference engine 22 performs a lookup of rules in the rule database 24 to compare aspects of an identified treatment or therapy plan to current patient parameters and information to ensure that the identified therapy or treatment plan is compatible with the current patient's condition. For instance, if the current patient's medical history indicates that the patient is allergic to erythromycin, which information is retrieved from the EMR 32, and the identified treatment plan calls for a 10-day regimen of erythromycin or another antibiotic that typically generates an allergic response in patients who are allergic to erythromycin, then the rule inference engine 22 alerts the user to the inconsistency.

The output from the guideline engine is then sent to the guideline-based CDSS interface. In this manner, the user interacts with the guideline-based CDSS interface to receive therapy and/or treatment suggestions based on patient histories that are relevant to the current patient's situation.

Internal software communication exists between the guideline-based CDSS engine 14 and image-based therapy monitoring software employed by the external imaging system(s) 44 such as CAD, CADx, and/or other imaging systems (e.g., PACS and the like). The clinical information systems 30 incorporate free-text data (encoded via NLP), facilitating access to image-related NLP encoded data such as neuroradiology MRI reports, as well as non-image NLP encoded data such as discharge summaries, by the CDSS engine.

The system 10 provides case-based treatment monitoring and planning functionality, as well as information retrieval for case-based reasoning and recommendations. For instance, the CDSS engine 14 is capable of querying other system components (e.g., clinical information systems 30, external CDSS 36, evidence links 40, external imaging systems 44, etc.) and retrieving results derived from case-based reasoning or inference based on medical variables or combination of variables associated with a current patient derived from the other system components. Medical variables include but are not limited to: clinical indications such as patient medical history including imaging information, family history, clinical stage of the disease, etc., which may be retrieved from clinical information systems 30, external CDSS 36, external imaging systems 44, etc.; demographic information (e.g. age, gender, occupation), which may be retrieved from clinical information systems 30, etc.; treatment plans, treatment outcomes, and adverse effects of drugs, which may be retrieved from clinical information systems 30, external CDSS 36, external imaging systems 44, etc.; image-based information for the discovery of imaging parameters relevant to treatment planning and monitoring, which may be retrieved from external imaging systems 44, etc.; combinations of clinical variables (including image-based and non-image-based information) with distance calculations for similarity matching and retrieval, which may be retrieved from clinical information systems 30, external CDSS 36, external imaging systems 44, etc.

According to an example, upon a query by the CDSS engine 14, patient history information including age, gender, occupation, and the like are retrieved from the EMR 32 and/or the NLP database 34 in the clinical information system 30. Image-based information is retrieved from one or more of the CAD 46, the PACS 48, and the CADx 50 of the external imaging system 44. Treatment plans, outcomes, and adverse drug effects are retrieved from the database 38 of the external CDSS system 36 and/or from the database 42 (e.g., Pubmed or the like) in the evidence links 40.

The case-based engine 20 includes one or more data-mining software modules for interfacing with the components of the system 10. For instance, case-based modules interface with the clinical information systems 30, external CDSS 36, evidence links 40, and external imaging systems 44, to retrieve information that is pertinent to a current or target patient's diagnosis, treatment, etc. Case-based modules group information as a function of one or more relevance metrics that indicate a relative closeness of a given piece of information (or a reference patient history) to a current or target patient's situation. In one embodiment, the case-based engine makes inferences and/or predictions relating to treatment outcomes (e.g. survival, tumor control and side effects).

In another embodiment, the guideline engine 16 tracks deviations from national or institutional guidelines. For instance, a physician who determines that a particular patient treatment is proving mildly effective and that no adverse effects are exhibited at a maximum dosage prescribed by a guideline can increase the dosage slightly beyond the recommended level. Such a deviation can be logged and included in the patient history for the patient along with results, treatment efficacy information, etc., which can be accessed or retrieved for guideline-based clinical decision support when continuing the treatment of the current patient or treating a future patient.

According to another embodiment, the case-based engine 20 receives case-based information related to reference patient data from a pool of patients in any of the clinical information systems 30, the external CDSS 36, the evidence links 40, and/or the external imaging systems 44, and compares the data to a current or target patient's data. Based on the comparison, the case-based engine generates a “distance” value that describes a level of similarity between the current patient and reference patients in the patient pool. Metrics used to calculate distance can include disease identity, treatment plan, tumor size and/or location, noted side effects, symptoms, signs, demographic information (e.g., patient age, occupation, location, ethnicity, etc). Once the reference patients from the patient pool are ranked according to their respective distance values relative to the current patient, relevant medical information from the reference patients (e.g., medical histories, treatments, dosages, regimens, results, side effects, etc.) is presented to the user (e.g., in a list or table) on the CDSS interface. In one embodiment, this information is displayed in a selection table 78 (see, e.g., FIG. 2), and a user can click on or otherwise select a displayed patient, medical history, treatment, etc., to retrieve more detailed information associated therewith. Information associated with relevant reference patients is optionally displayed in order of calculated distance values, with a “closest” patient being listed first. A user can then click on a similar patient and view that patient's history, treatment results, etc.

In a related embodiment, ranked patient information is present to the user along with treatment or diagnosis recommendations or suggestions, which are generated as a function of the distance value(s). Moreover, deviation(s) from prescribed guidelines can be recommended based on previous success with similar deviations, noted differences between the current patient and patients selected from the patient pool (e.g., weight, age, etc.), etc.

According to an example, a user enters information for a current patient (e.g., age, weight, body mass index value, symptoms, signs, image data, etc.) into the guideline-based CDSS via an input device. The guideline-based CDSS retrieves from a hospital PACS or EMR database or the like, image information related to a tumor in the patient, including actual images, tumor size, texture, and position information, etc. Alternatively, a natural language processing codec is employed to extract data from EMR 32. The guideline-based CDSS engine 14 for example retrieves a guideline for the particular patient's attributes that recommends that the tumor be decreased in its volume, if possible, to a predetermined size (e.g., using chemotherapy techniques or the like) and then removed. The CDSS engine then searches one or more medical databases (e.g., EMR 32, NLP database 34, external CDSS database 38, evidence links 40, external imaging systems 44 including CAD 46, PACS 48, CADx 50, etc.) having stored therein patient data from previous patients, calculates distance values for patients having the most similar patient histories (e.g., similarly sized and located tumors, ages, sexes, etc.), and returns a predefined number (e.g., 5, 10, etc.) of closest matches to the user. In one embodiment, the user is able to adjust the number of returned matches by adjusting a threshold of minimum similarity needed to retrieve a patient from a database as similar to the patient in question.

The user is then presented with a list or table of relevant reference patients and/or related information from one or more of the databases (e.g., EMR 32, NLP database 34, external CDSS database 38, evidence links 40, external imaging systems 44 including CAD 46, PACS 48, CADx 50, etc.), which may be stored in memory 54, and selects a patient to view more detailed information (e.g., treatment, efficacy, side effects, etc.) and employs such information to generate a personalized treatment guideline for the current patient. The personalized guideline may include, for example, a target size to which the user prefers to reduce the current patient's tumor before removal, treatment dosages and schedules, and the like. To further this example, if the user selects a treatment guideline involving a treatment dosage that is above a predetermined acceptable threshold given the current patient's weight, metabolism, etc., the rule inference engine 22 provides an alert to the user, to notify the user of the issue. The user can then review the dosage, reduce the dosage, override the alert and deviate from the treatment guideline, etc.

In a related example, the current patient is imaged using an imaging technique (not shown) such as X-ray, computed tomography (CT), positron emission tomography (PET), single photon emission computed tomography (SPECT), magnetic resonance imaging (MRI), and/or variants of the foregoing, etc. Patient images are stored in a CAD 46, CADx 50, or PACS 48 system and retrieved by the user. The CDSS engine 14 then compares current patient attributes (e.g. images) to patients in the patient database to generate the distance value as a function of, for instance, tumor location, size, texture, etc., and returns relevant patient information to the user for comparison with current patient information and generation of a personalized treatment guideline(s). In this manner, communication is facilitated between the guideline-based CDSS engine 14 and external imaging systems 44.

FIG. 2 is a screenshot of the CDSS interface 12, in accordance with various aspects described herein. The interface consists of several panes. According to an example, the left pane or window 70 presents users with a current patient's electronic medical information (e.g., retrieved from an electronic patient record, hospital information system, radiology information system, or the like) in the form of editable and non-editable fields. The upper-right pane 72 depicts a graphical guideline with a current active node 74 highlighted. The lower-right pane 76 shows a designed, multiple choice selection table 78 with links to external information in the form of tables 80 and HTML links 82.

According to an example, a report automatically displays a user's choice of treatments in the upper-right window 72. Recommended dosing is automatically calculated using, for instance, body surface area (BSA) equations listed in a drop down menu. Scheduling capabilities are also included in the report. The schedule date can be selected via a drop-down calendar, and dates are automatically updated based on the duration and frequency of treatment cycles. The report can include extended functionalities, such as patient toxicity tracking and the like.

FIG. 3 is a screenshot of the CDSS interface 12 wherein a link to external imaging software and/or database(s) has been selected causing a window to be opened displaying patient images 90 retrieved by a software module that accesses the external imaging software and/or database(s). The guideline-based CDSS can exchange medical information (both imaging and non-imaging data) via an internal socket connection or the like with the external imaging software and/or database(s). The connection is bi-directional.

In one embodiment, the system is used for lung cancer therapy and treatment monitoring; however, the methods and systems described herein can be applied to any medical domain and/or disease.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A guideline-based clinical decision support system (CDSS) (10), including:
a guideline engine (16) that executes one or more guidelines (28) for treating a current patient; and
an external image system (44) that interfaces with the guideline engine (16).

2. The system according to claim 1, further including a case-based data-mining engine (20) that compares current patient attributes to attributes of reference patients stored in the external imaging system (44) and determines a distance value that describes a level of similarity between the current patient and respective reference patients.

3. The system according to claim 2, further including a guideline authoring tool (26) that receives user input related to the current patient for generating a custom treatment guideline for the current patient.

4. The system according to claim 3, further including a rule-based engine (22) that provides an alert to a user when the custom treatment guideline conflicts with a predefined rule stored in a rule database (24).

5. The system according to claim 3, further including an ontology engine (18) that communicates with one or more clinical information systems (30) to retrieve reference patient attribute information for comparison to attributes associated with the current patient.

6. The system according to claim 5, wherein the one or more clinical information systems (30) include an electronic medical record database (32) and a natural language information database (34) that store information related to reference patients.

7. The system according to claim 6, wherein the case-based data-mining engine (20) is further coupled to and retrieves information from:
the one or more clinical information systems (30);
an external CDSS (36);
one or more evidence links (40); and
one or more external imaging systems (44).

8. The system according to claim 7, wherein the case-based data-mining engine (20) executes a natural language processing codec to retrieve information from the one or more clinical information systems (30), the external CDSS (36), or the one or more evidence links (40).

9. The system according to claim 8, further including a guideline-based CDSS interface (12) that presents current patient information, reference patient information, recommended guideline information, and custom guideline information to the user.

10. The system according to claim 2, wherein the user selects one or more reference patients from a list of reference patients whose patient information has a distance value below a predetermined threshold, in order to view more detailed information related to the selected reference patient.

11. The system according to claim 10, wherein the detailed information includes one or more of patient history, a patient image representation, treatment regimen, efficacy of treatment, dosage, dosing schedule, and side effects experienced by the reference patient.

12. The system according to claim 1, wherein the external imaging system includes at least one of:
a computer-aided detection (CAD) image system (46);
a computer-aided diagnosis (CADx) image system (48); and
a picture archiving and communication systems (PACS) (50).

13. The system according to claim 1, wherein attributes include at least one of size, volume, shape, texture, position, and functional parameters of a tumor or anatomical structure.

14. The system according to claim 1, wherein the guideline engine (16) includes one or more processors configured to:
compare attributes of the current patient to attributes of reference patients retrieved;
determine a distance value for at least one reference patient, the distance value being indicative of a level of similarity between the at least one reference patient and the current patient;
present to a user information associated with the at least one reference patient;
receive treatment guideline input from the user as a function of the reference patient information; and
generate and optimize a custom treatment guideline for the current patient from the received treatment guideline input.

15. A method of incorporating medical image information into clinical decision support system (CDSS) information, including:
comparing attributes of a current patient to attributes of one or more reference patients retrieved from an external imaging system (44); and
generating a custom treatment guideline for the current patient as a function of one or more treatment guidelines associated with the relevant reference patients.

16. The method according to claim 15, further including:
evaluating a level of similarity between the current patient and the one or more reference patients; and
presenting to a user reference patient information for reference patients identified as being relevant for having a level of similarity above a predetermined threshold level.

17. The method according to claim 16, further including retrieving reference patient attribute information from at least one of a computer-aided detection (CAD) imaging system (46), a computer-aided diagnosis (CADx) imaging system (48), or a picture archiving and communication systems (PACS) (50).

18. The method according to claim 15, further including comparing attributes including at least one of size, shape, texture, anatomical location, and functional parameters of a tumor or anatomical structure represented in a current patient image and one or more reference patient images.

19. The method according to claim 16, wherein presenting reference information to the user further includes:
presenting a ranked list of reference patients to the user in order of similarity between the reference patients and the current patient;
presenting at least one of a reference patient image, patient history, treatment regimen, treatment efficacy information, side effect information, dosage, and dosing schedule for a reference patient upon selection of the reference patient by the user.

20. The method according to claim 19, further including recommending a treatment guideline to the user based at least in part on treatment guidelines implemented for a relevant reference patient.

21. The method according to claim 20, further including permitting the user to modify the recommended treatment guideline to create the custom treatment guideline for the current patient.

22. The method according to claim 15, further including optimizing the custom treatment guideline for the current patient as a function of user input related to the one or more treatment guidelines.
